(19) United States
(12) Patent Application Publication
(10) Pub. No.: US 2012/0153849 A1
(43) Pub. Date: Jun. 21, 2012

(54) AC DRIVEN LIGHT EMITTING DEVICE

(76) Inventors: Young Jin LEE, Seoul (KR); Hyung Kun Kim, Suwon (KR)

(21) Appl. No.: 13/324,514

(22) Filed: Dec. 13, 2011

(30) Foreign Application Priority Data
Dec. 15, 2010 (KR) 10-2010-0128346

(51) Int. Cl. H05B 37/02

(52) U.S. Cl. 315/192

(57) ABSTRACT

Provided is an alternating current (AC) driven light emitting device, including: a plurality of half-wave driving units respectively having at least one light emitting diode (LED) and provided in a loop connecting respective half-wave driving unit terminals; and at least one full-wave driving unit having at least one LED and connecting one node between two of the plurality of half-wave driving units to another node between another two of the plurality of half-wave driving units, at least one of the half-wave driving unit and the full-wave driving unit having a parallel connection structure of at least two LEDs. An array of LEDs appropriate to being drivable by AC is provided to secure reliability in error in operation of some LEDs.

### CROSS-REFERENCE TO RELATED APPLICATIONS

This application claims the priority of Korean Patent Application No. 10-2010-0128346 filed on Dec. 15, 2010, in the Korean Intellectual Property Office, the disclosure of which is incorporated herein by reference.

### BACKGROUND OF THE INVENTION

1. Field of the Invention

The present invention relates to an AC driven light emitting device.

2. Description of the Related Art

A light emitting diode (LED), a semiconductor light emitting device, has been usefully used as a light source in view of the light output as well as the efficiency and reliability thereof, therefore, as a high output and highly efficient light source able to replace a backlight of an illumination or display device, LED research and development is actively being carried out.

In general, an LED is driven by direct current (DC) having a relatively low level of voltage. Therefore, in order to drive the LED at a regular level of voltage, i.e., with alternating current (AC) of 220V, an additional circuit, i.e., an AC-DC converter, supplying a relatively low DC output voltage, is required. However, the inclusion of this additional circuit may complicate the configuration of an LED module, and furthermore, may deteriorate efficiency and reliability during a conversion process of supply power. In addition, product cost may increase and the size of products may increase due to an installation of additional components in the light source thereof, and electromagnetic interference (EMI) properties may be degraded due to periodic components in a switching mode operation.

In order to solve these defects, various types of LED driving circuits able to be driven by an AC voltage without an additional converter have been proposed. However, since most LEDs in an AC drive-type LED driving circuit are generally arrayed to be driven only at a specific half-period of AC voltage, the number of LEDs required to obtain a desired light quantity may greatly increase.

The required number of LEDs may differ according to LED array methods, even for the same quantity of light emission. The LED array method according to the related art has relatively low efficiency. For example, in a representative reverse parallel array or bridge array method according to the related art, the number of LEDs consecutively emitting light may actually correspond to merely around 50% and 60% of the total number of LEDs respectively. That is, there is inefficiency in which the number of consumed LEDs should be relatively large in order to achieve a desired light emission level.

Therefore, the same quantity of light may be provided using relatively small quantities of LEDs through an efficient LED array, which is a very important issue in manufacturing AC drive-type LED circuits and selling products thereof from an economic viewpoint. Further, in actually implementing an AC driven light emitting device, the connection among respective units of LED cells may be generally complicated. Thus, a wiring connection method and a formation process thereof may be complicated while degrading productivity. Moreover, since a large number of LED cells may have a complicated connection structure, it is recognized as an important issue to design a miniaturized type of circuit and device so as to have a relatively high level of integration.

### SUMMARY OF INVENTION

An aspect of the present invention provides an alternating current (AC) driven light emitting device having light emitting diodes (LEDs) appropriately arrayed for driving by an AC voltage, and able to secure reliability in an error rate in an operation of some LEDs thereof.

According to an aspect of the present invention, there is provided an alternating current (AC) driven light emitting device including: a plurality of half-wave driving units respectively having at least one light emitting diode (LED) and provided in a loop connecting respective half-wave driving unit terminals; and at least one full-wave driving unit having at least one LED and connecting one node between two of the plurality of half-wave driving units to another node between another two of the plurality of half-wave driving units, at least one of the half-wave driving unit and the full-wave driving unit having a parallel connection structure of at least two LEDs.

The LED included in the at least one of the plurality of half-wave driving units may be disposed in a different direction to that of an LED included in the half-wave driving unit adjacent thereto.

The full-wave driving unit may be provided in a plural number, and the LED included in the at least one of the plurality of full-wave driving units may be disposed in a different direction to that of an LED included in the full-wave driving unit adjacent thereto.

For the at least one of the half-wave driving unit and the full-wave driving unit having the parallel connection structure, the parallel connection may be provided by at least two parallel connections to have a serial connection therebetween.

The at least one of the half-wave driving units may have the parallel connection of at least two LEDs, and the at least one of the full-wave driving units may have a serial connection of at least two LEDs.

In this case, the size of the LED included in the half-wave driving unit may be smaller than that of the LED included in the full-wave driving unit.

At least two nodes connected to the half-wave driving units may not be connected to the full-wave driving unit, and the two nodes to which the full-wave driving unit is not connected may be provided as external power connection terminals.

The AC driven light emitting device may further include a substrate serving as a mounting area of a plurality of LEDs included in the half-wave driving units and the full-wave driving units, and the plurality of LEDs may form a light emitting area rectangularly shaped when viewed from above.

In this case, the half-wave driving unit may be disposed at an edge of the light emitting area, and the full-wave driving unit may be disposed at a center of the light emitting area.

The half-wave driving units may be disposed along two opposed sides of the light emitting area, and the full-wave driving unit may be disposed between the half-wave driving units.

The LEDs may be connected to each other in a chip state.

The LEDs may be implemented as a package to be connected to other packages.

### BRIEF DESCRIPTION OF DRAWINGS

The above and other aspects, features and other advantages of the present invention will be more clearly understood from the following detailed description taken in conjunction with the accompanying drawings, in which:

FIG. 1 is a circuit diagram of an equivalent circuit of an AC driven light emitting device connected to AC power according to an embodiment of the present invention;

FIGS. 2 and 3 illustrate operation states in voltages applied in respective forward and reverse directions in the AC driven light emitting device shown in FIG. 1;

FIG. 4 is a state diagram illustrating an operation of a half-wave driving unit in the AC driven light emitting device shown in FIG. 1;

FIGS. 5 and 6 are circuit diagrams of equivalent circuits to an AC driven light emitting device according to a varied embodiment from the AC driven light emitting device shown in FIG. 1;

FIG. 7 illustrates an array type of LEDs in the AC driven light emitting device shown in FIG. 6;

FIG. 8 is a circuit diagram of an equivalent circuit of an AC driven light emitting device according to another embodiment of the present invention;

FIG. 9 is a circuit diagram of an equivalent circuit of an AC driven light emitting device according to another embodiment of the present invention; and

FIG. 10 is a schematic state diagram illustrating an array state of LEDs in the AC driven light emitting device shown in FIG. 9.

### DETAILED DESCRIPTION OF PREFERRED EMBODIMENT

Exemplary embodiments of the present invention will now be described in detail with reference to the accompanying drawings such that they could be easily practiced by those having skill in the art to which the present invention pertains. However, in describing the exemplary embodiments of the present invention, detailed descriptions of well-known functions or constructions will be omitted so as not to obscure the description of the present invention with unnecessary detail.

In addition, like reference numerals denote like elements throughout the drawings.

Unless explicitly described to the contrary, the word “comprise” and variations such as “comprises” or “comprising,” will be understood to imply the inclusion of stated elements but not the exclusion of any other elements.

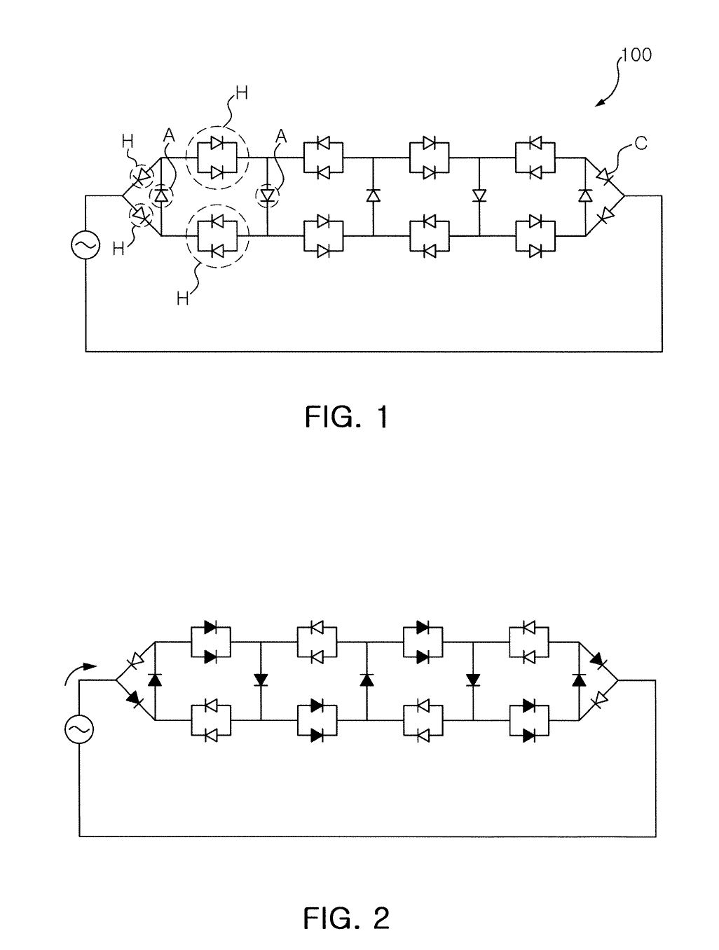

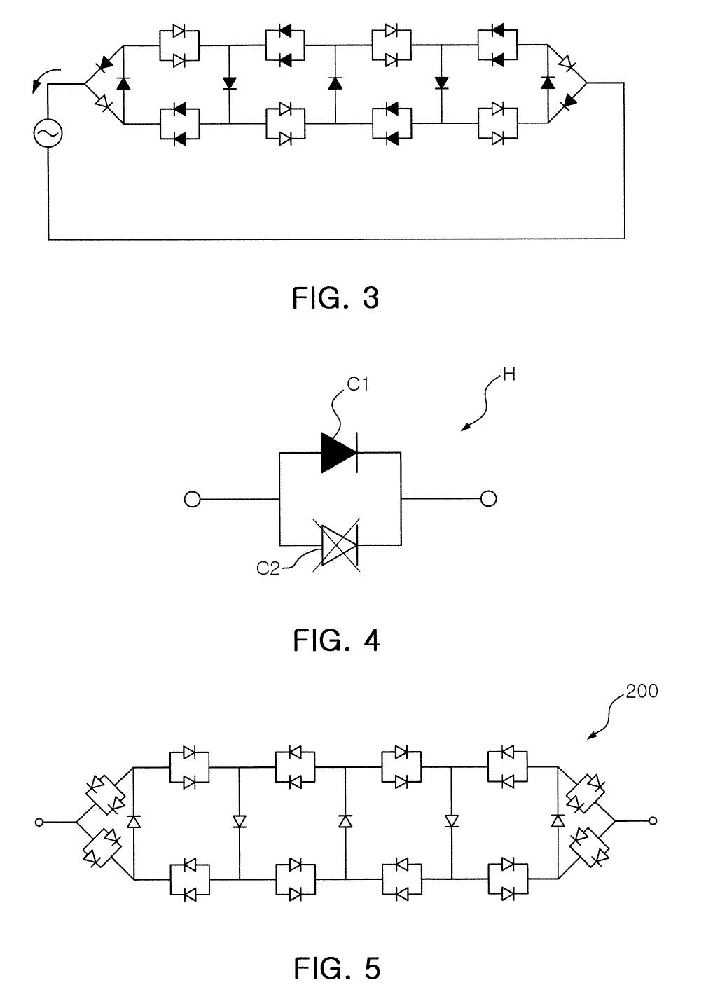

FIG. 1 is a circuit diagram of an equivalent circuit of an AC driven light emitting device connected to AC power according to an embodiment of the present invention. FIGS. 2 and 3 illustrate operation states in voltages applied in respective forward and reverse directions in the AC driven light emitting device shown in FIG. 1. FIG. 4 is a state diagram illustrating an operation of a half-wave driving unit in the AC driven light emitting device shown in FIG. 1.

Referring first to FIG. 1, according to an embodiment of the present invention, an AC driven light emitting device 100 may include a half-wave driving unit H and a full-wave driving unit A in a connection structure in which a plurality of LEDs C are connected to be driven by all of forward and reverse voltages for AC power. The connection of the plurality of LEDs C may be implemented in a chip state or after packaging the respective LEDs. In the half-wave driving unit H, the LEDs may be disposed to operate by voltages applied in either of forward or reverse directions and emit light from the AC power. Described in detail, the AC driven light emitting device 100 may include a plurality of half-wave driving units H, and each of the half-wave driving units H may have at least one LED. The plurality of half-wave driving units H may be loop shaped through connecting respective terminals to one another as shown in FIG. 1. In this case, at least two nodes connected to the half-wave driving units H are not connected to the full-wave driving unit A, and the two nodes to which the full-wave driving unit A is not connected are provided as external power connection terminals. In addition, an LED included in a specific half-wave driving unit H may be disposed in a direction different from that of an LED included in its adjacent half-wave driving unit H. Accordingly, the LEDs may operate with voltages applied in either forward or reverse directions as being indicated by LEDs emitting light depicted as dark in FIGS. 2 and 3, and the same number of LEDs may emit light by voltages of both directions being applied thereto. Meanwhile, even though the half-wave driving unit H is represented as a portion of the left part of the diagram thereof, all portions emitting light due to a unidirectional voltage in one direction only may correspond to the half-wave driving units H in FIGS. 2 and 3.

The full-wave driving unit A may operate with bidirectional voltages, and at least one full-wave driving unit A may be included in the AC driven light emitting device 100, for which, for example, five full-wave driving units A may be used according to the embodiment of the present invention. In this case, as shown in FIG. 1, the full-wave driving unit A may be disposed so as to connect one node between two half-wave driving units H to another node between the other two half-wave driving units H. FIG. 1 illustrates the full-wave driving unit A only in a portion of the left of the drawing, but in FIGS. 2 and 3, all parts emitting light with bidirectional voltages may be the full-wave driving units A. In addition, similarly to the half-wave driving unit H, in the full-wave driving unit A, an LED included in the half-wave driving unit H may be disposed in a direction different from that of an LED included in its adjacent half-wave driving unit H, such that the AC driven light emitting device 100 may be driven by AC power.

According to the embodiment of the present invention, at least one of the half-wave driving unit H and the full-wave driving unit A may have at least two LEDs connected in parallel, and the embodiment here provides an example in which the half-wave driving unit H has the parallel-connection structure. As shown in FIG. 4, even in the case an LED C2 connected by a parallel connection structure has defect, a further LED C1 may operate to maintain an overall operation of a circuit. In this case, a defect in the LED C2 may relate to an open defect. For example, when the half-wave driving unit H has a single LED or only a serial connection structure of LEDs, the overall circuit may not operate in the case of open detect. Accordingly, in the embodiment of the present invention, the parallel connection structure of LEDs used in the half-wave driving unit H may enhance the overall reliability of the AC driven light emitting device 100. Though not shown specifically, the parallel connection structure may also be effectuated equally in a case of the full-wave driving unit A. Further, in the embodiment of the present invention, the number of LEDs connected in parallel is illustrated in two as an example, but three or more LEDs may be used, in which the reliability may more increase.

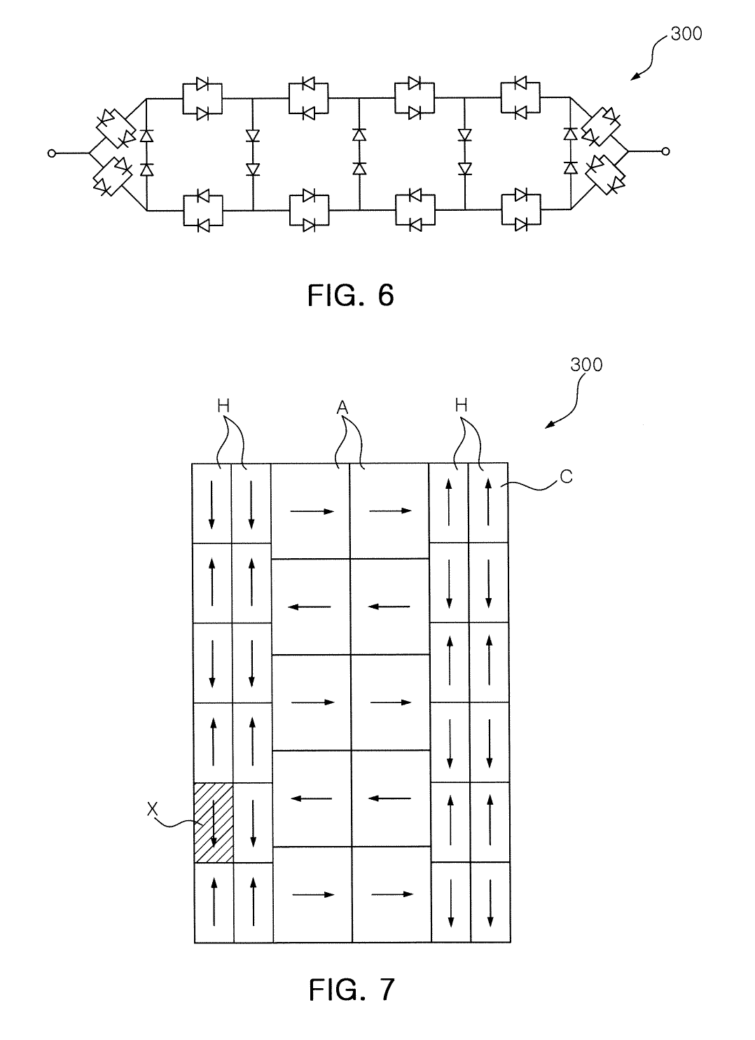

FIGS. 5 and 6 are circuit diagrams of equivalent circuits to an AC driven light emitting device according to a varied embodiment from the AC driven light emitting device shown in FIG. 1. Referring first to FIG. 5, in AC driven light emitting device 200 according to an embodiment of the present invention, all half-wave driving units have a parallel connection structure for the LEDs thereof. In the embodiment referred to in FIG. 1, only the half-wave driving units H positioned between full-wave driving units A have the parallel connection structure, which is because, in the half-wave driving units H positioned between two full-wave driving units A, a relatively high level of reverse voltage is applied in a non-emission case so as to require greater reliability. According to the embodiment of the present invention, the parallel connection structure may be applied entirely to the half-wave driving units, thereby increasing reliability in the operation of the AC driven light emitting device 200.

Subsequently, in an AC driven light emitting device 300 according to the embodiment referred to in FIG. 6, the full-wave driving unit may have a structure in which a plurality of LEDs are connected in series, for example, two LEDs in the embodiment of the invention, as compared to the AC driven light emitting device of FIG. 5. The plurality of LEDs may be used in the full-wave driving unit such that the number of LEDs emitting light in both directions increases and the light emission efficiency of the AC driven light emitting device 300 may increase. In this case, an increase in the number of LEDs used in the full-wave driving unit may bring about a relatively greater reverse voltage applied in a non-illumination case to the half-wave driving unit disposed between the full-wave driving units, whereby reliability in the half-wave driving units may become more important and the parallel connection structure in the half-wave driving units may act more usefully.

The above-descriptions are principally provided with reference to the equivalent circuit diagram, and, in describing an actual array shape of the LEDs, FIG. 7 schematically illustrates the shape of an array of LEDs used in the AC driven light emitting device of FIG. 6. FIG. 7 provides a view of LEDs C disposed on a substrate (not shown) from above, in which arrows indicate directions of current flowing to respective LEDs C by AC power, that is, the directions in which LEDs are disposed. In the embodiment of the present invention, as shown in FIG. 7, pluralities of LEDs C may form a rectangularly shaped light emitting area. Further, the half-wave driving unit H may be disposed at an edge of the light emitting area, and the full-wave driving unit A may be disposed at a center of the light emitting area. Described in greater detail, the half-wave driving units H may be disposed along two opposed sides of the light emitting area, and the full-wave driving unit A may be disposed between the half-wave driving units H. In this case, in the parallel connection structure of the LEDs, the LEDs included in the half-wave driving unit H may be smaller than the LEDs included in the full-wave driving unit A. Accordingly, even though a defective LED X is caused, an influence therefrom may be relatively reduced.

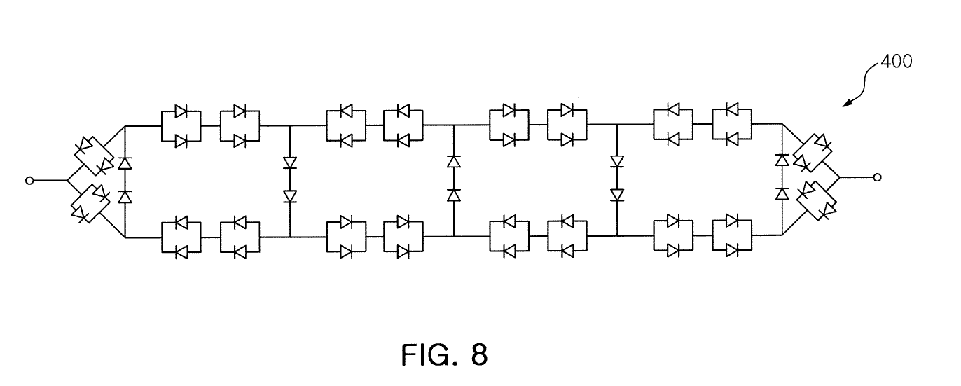

FIG. 8 is a circuit diagram of an equivalent circuit of AC driven light emitting device according to another embodiment of the present invention. An AC driven light emitting device 400 according to the embodiment of the present invention may have a basically similar structure to the AC driven light emitting device of FIG. 6, while half-wave driving units may have both parallel and serial connection structures. In detail, the half-wave driving unit may have a parallel connection structure of pluralities of LEDs connected in parallel to each other, and this parallel connection structure may be also provided in a plural number, for example, two parallel connections in the embodiment, where the two parallel connections may have a serial connection structure. Even though in the LEDs connected to each other in series, short-circuit defects occur in some LEDS during operation, an operation of the overall device may be maintained. In addition, in a case of non-light emission, a magnitude of a reverse voltage applied to a single LED disposed in the half-wave driving unit may be reduced, and therefore it may be expected to enhance reliability. As such, according to the embodiment, this parallel and serial combined connection structure of LEDs may correspond to both of open and shorted-circuit occurrences in LEDs.

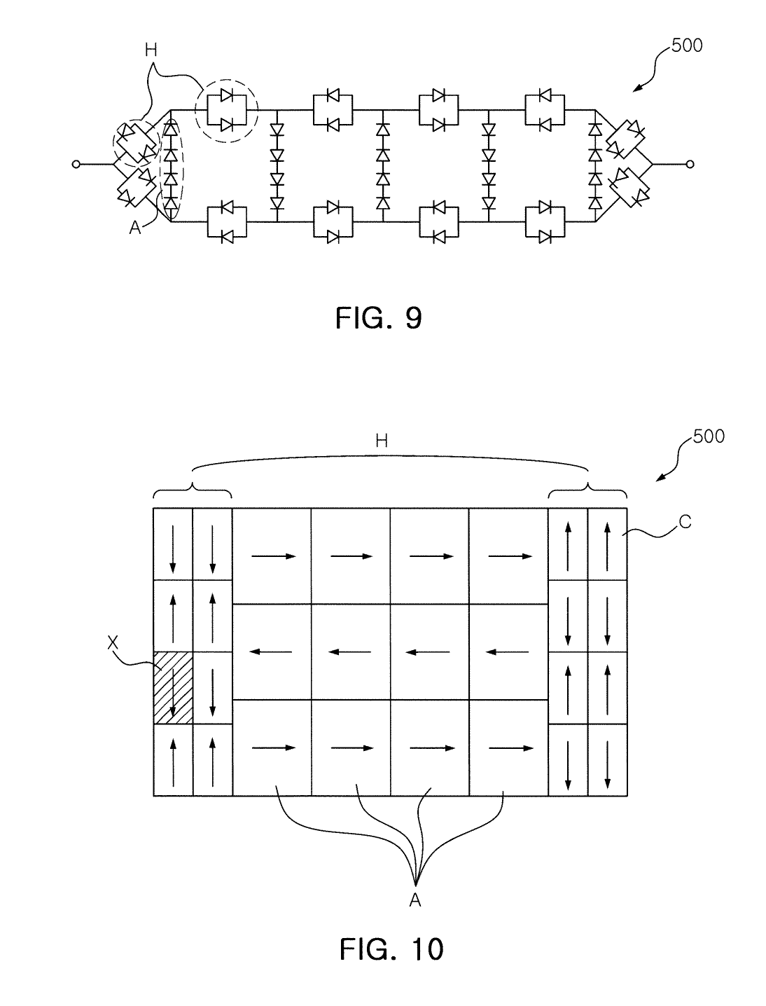

FIG. 9 is a circuit diagram of an equivalent circuit of an AC driven light emitting device according to another embodiment of the present invention, and FIG. 10 is a schematic state diagram illustrating an array of LEDs in the AC driven light emitting device shown in FIG. 9. An AC driven light emitting device 500 according to the embodiment of the present invention may have a basically similar structure to the AC driven light emitting device of FIG. 6, while full-wave driving units A may have a serial connection structure of four LEDs. As the number of LEDs disposed in the full-wave driving unit A increases, light emitting efficiency for both directions of overall voltage may increase. With reference to FIG. 10, in this embodiment, pluralities of LEDs C may form a rectangularly shaped light emitting area. Further, the half-wave driving unit H may be disposed at an edge of the light emitting area, and the full-wave driving unit A may be disposed at a center of the light emitting area. Described in greater detail, the half-wave driving units H may be disposed along two opposed sides of the light emitting area, and the full-wave driving unit A may be disposed between the half-wave driving units H. In this case, in the parallel connection structure of the LEDs, the LEDs included in the half-wave driving unit H may be smaller than the LEDs included in the full-wave driving units A. Accordingly, even though a defective LED X is generated, an influence thereof may be relatively reduced.

As set forth above, according to an embodiment of the present invention, an array of LEDs appropriate for driving by AC is provided to secure reliability in error in the operation of some LEDs.

While the present invention has been shown and described in connection with the exemplary embodiments, it will be apparent to those skilled in the art that modifications and variations can be made without departing from the spirit and scope of the invention as defined by the appended claims.

What is claimed is:

1. An alternating current (AC) driven light emitting device, comprising:
a plurality of half-wave driving units respectively having at least one light emitting diode (LED) and provided in a loop connecting respective half-wave driving unit terminals; and
at least one full-wave driving unit having at least one LED and connecting one node between two of the plurality of half-wave driving units to another node between another two of the plurality of half-wave driving units, at least one of the half-wave driving unit and the full-wave driving unit having a parallel connection structure of at least two LEDs.

2. The device of claim 1, wherein the LED included in at least one of the plurality of half-wave driving units is disposed in a different direction to that of an LED included in the half-wave driving unit adjacent thereto.

3. The device of claim 1, wherein the full-wave driving unit is provided in a plural number, and the LED included in at least one of the plurality of full-wave driving units is disposed in a different direction to that of an LED included in the full-wave driving unit adjacent thereto.

4. The device of claim 1, wherein for the at least one of the half-wave driving unit and the full-wave driving unit having the parallel connection structure, the parallel connection structure is provided by at least two parallel connections to have a serial connection therebetween.

5. The device of claim 1, wherein the at least one of the half-wave driving units has the parallel connection of at least two LEDs, and the at least one of the full-wave driving units has a serial connection of at least two LEDs.

6. The device of claim 5, wherein the size of the LED included in the half-wave driving unit is smaller than that of the LED included in the full-wave driving unit.

7. The device of claim 1, wherein at least two nodes connected to the half-wave driving units are not connected to the full-wave driving unit, and the two nodes to which the full-wave driving unit is not connected are provided as external power connection terminals.

8. The device of claim 1, further comprising a substrate serving as a mounting area of a plurality of LEDs included in the half-wave driving units and the full-wave driving units, the plurality of LEDs forming a light emitting area rectangularly shaped when viewed from above.

9. The device of claim 8, wherein the half-wave driving unit is disposed at an edge of the light emitting area, and the full-wave driving unit is disposed at a center of the light emitting area.

10. The device of claim 9, wherein the half-wave driving units are disposed along two opposed sides of the light emitting area, and the full-wave driving unit is disposed between the half-wave driving units.

11. The device of claim 1, wherein the LEDs are connected to each other in a chip state.

12. The device of claim 1, wherein the LEDs are implemented as a package to be connected to other packages.
